(19) United States
(12) Patent Application Publication
(10) Pub. No.: US 2006/0212426 A1
(43) Pub. Date: Sep. 21, 2006

(54) Efficient CAM-based techniques to perform string searches in packet payloads

(76) Inventors: Udaya Shakara, Bangalore (IN); Manoj Paul, Bangalore (IN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/018,942

(22) Filed: Dec. 21, 2004

(51) Int. Cl. G06F 17/30

(52) U.S. Cl. 707/3

(57) ABSTRACT

Efficient Content Addressable Memory (CAM)-based techniques for performing string searches in packet payloads. Hashes are performed on hash keys comprising overlapping sub-strings in one or more search strings. The resulting hash values are stored in a CAM. During packet processing operations, a search of the packet payload data is made to determine if any of the search strings are present. Hashes are performed on non-overlapping sub-strings in the payload data, and the hash results are submitted to the CAM for comparison with the previously-generated search string hash values. If no CAM hits result, the payload data does not contain any of the search strings, while a CAM hit indicates that at least one of the search strings might be present in the payload data. In this instance, a full string comparison is made between the search strings (or an identified search string) and strings in the payload data to verify whether a search string is actually present.

### FIELD OF THE INVENTION

The field of invention relates generally to computer and communication networks and, more specifically but not exclusively relates to techniques for performing string searches in packet payloads.

### BACKGROUND INFORMATION

Network devices, such as switches and routers, are designed to forward network traffic, in the form of packets, at high line rates. One of the most important considerations for handling network traffic is packet throughput. To accomplish this, special-purpose processors known as network processors have been developed to efficiently process very large numbers of packets per second. In order to process a packet, the network processor (and/or network equipment employing the network processor) needs to extract data from the packet header indicating the destination of the packet, class of service, etc., store the payload data in memory, perform packet classification and queuing operations, determine the next hop for the packet, select an appropriate network port via which to forward the packet, etc. These operations are generally referred to as “packet processing” operations.

Modern network processors perform packet processing using multiple multi-threaded processing elements (e.g., processing cores) (referred to as microengines or compute engines in network processors manufactured by Intel® Corporation, Santa Clara, Calif.), wherein each thread performs a specific task or set of tasks in a pipelined architecture. During packet processing, numerous accesses are performed to move data between various shared resources coupled to and/or provided by a network processor. For example, network processors commonly store packet metadata and the like in static random access memory (SRAM) stores, while storing packets (or packet payload data) in dynamic random access memory (DRAM)-based stores. In addition, a network processor may be coupled to cryptographic processors, hash units, general-purpose processors, and expansion buses, such as the PCI (peripheral component interconnect) and PCI Express bus.

In general, the various packet-processing compute engines of a network processor, as well as other optional processing elements, will function as embedded specific-purpose processors. In contrast to conventional general-purpose processors, the compute engines do not employ an operating system to host applications, but rather directly execute “application” code using a reduced instruction set. For example, the microengines in Intel's IXP2xxx family of network processors are 32-bit RISC processing cores that employ an instruction set including conventional RISC (reduced instruction set computer) instructions with additional features specifically tailored for network processing. Because microengines are not general-purpose processors, many tradeoffs are made to minimize their size and power consumption.

In addition to the foregoing packet forwarding operations, there may be a need to search packet payloads for a given string or set of strings. For example, security applications may need to search for certain strings indicative of a virus or Internet worm that is present in the packet. Other applications may likewise need to peek into the packet payload, such as for load balancing or billing purposes.

Searching packet payloads presents a problem with respect to line-rate packet forwarding. The reason for this is that string searches may be very time consuming, especially if the strings are relatively long. In contrast, packet forwarding typically has a pre-defined overall latency built into the sequence of operations required to forward a packet. The overall latency is the sum of individual latencies corresponding to packet processing operations that are well-defined. The net result is that it is currently impracticable to perform string searching of packet payloads and maintain line rate speeds. In addition, current compute engine architectures do not support efficient string search capabilities.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a flowchart illustrating operations and logic employed to determine if one or more search strings are present in packet payload data, according to one embodiment of the invention;

FIG. 2a is a flowchart illustrating operations and logic used to generate hash values from overlapping sub-strings in the search strings, wherein each sub-string has a length of L_{KEY} and there are L_{KEY} hash values stored for each search string;

FIG. 2b is a flowchart illustrating operations and logic used to generate hash values from overlapping sub-strings in the search strings, wherein each sub-string has a length of L_{KEY} and the number of sub-strings used to generate the hash values for each search string correspond to the number of sub-strings required to span the shorted search string;

FIG. 3a is a schematic diagram illustrating a first exemplary set of hash values generated by performing the process of FIG. 2a, wherein L_{KEY}=3;

FIG. 3b is a schematic diagram illustrating a first exemplary set of hash values generated by performing the process of FIG. 2a, wherein L_{KEY}=5;

FIG. 3c is a schematic diagram illustrating a full set of hash values generated by performing the process of FIG. 2b, wherein L_{KEY}=3;

FIG. 3d is a schematic diagram illustrating a full set of hash values generated by performing the process of FIG. 2b, wherein L_{KEY}=5;

FIG. 4a is a flowchart illustrating operation and logic performed during one embodiment of run-time processing to verify the presence of a search string in a packet payload, wherein hash results derived from adjacent non-overlapping sub-strings in the payload are compared with hash values in the CAM;

FIG. 4b is a flowchart illustrating operation and logic performed during one embodiment of run-time processing to verify the presence of a search string in a packet payload, wherein hash results derived from a reduced number of sub-strings separated by offsets are compared with hash values in the CAM;

FIG. 5a is a schematic diagram illustrating an example of the search string verification process of FIG. 4a, wherein L_{KEY}=3 and a search is performed on a generic search string;

FIG. 5b is a schematic diagram illustrating an example of the search string verification process of FIG. 4a, wherein L_{KEY}=3 and a search is performed on a search string comprising an “EVILINTERNETWORM” ASCII 8-bit character byte sequence;

FIG. 5c is a schematic diagram illustrating an example of the search string verification process of FIG. 4a, wherein L_{KEY}=3 and a search is performed on the search “EVILINTERNETWORM” search stream, and wherein a false hit on a packet payload including a string comprising “VILLAGEOFTHEDAMNED” is detected;

FIG. 6a is a schematic diagram illustrating an example of the search string verification process of FIG. 4a, wherein L_{KEY}=5 and a search is performed on the generic search string of FIG. 5a;

FIG. 6b is a schematic diagram illustrating an example of the search string verification process of FIG. 4a, wherein L_{KEY}=5 and a search is performed on the “EVILINTERNETWORM” search string of FIG. 5b;

FIG. 6c is a schematic diagram illustrating an example of the search string verification process of FIG. 4a, wherein L_{KEY}=5 and a search is performed on the “EVILINTERNETWORM” search string, and wherein a search on a packet payload including a string comprising “VILLAGEOFTHEDAMNED” does not generate a false hit;

FIG. 7a is a schematic diagram illustrating a set of hash values generated by performing the process of FIG. 2b on a generic search string, wherein L_{KEY}=3;

FIG. 7b is a schematic diagram illustrating the packet payload search process of FIG. 4b being performed on the generic search string of FIG. 7a;

FIG. 8 is a schematic diagram illustrating one embodiment of an optimization scheme, wherein hash values may be removed from a combined set of hash values employed for searching multiple strings;

FIG. 9 is schematic diagram of a compute engine including a CAM and local hash unit, according to one embodiment of the invention;

FIG. 10 is a schematic diagram illustrating a technique for performing multiple functions via multiple compute engines using a context pipeline; and

FIG. 11 is a schematic diagram of a network line card employing a network processor that employs microengines used to execute threads to perform packet payload string search operations in accordance with the embodiments disclosed herein.

### DETAILED DESCRIPTION

Embodiments of methods and apparatus for performing efficient packet payload string searches are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In accordance with aspects of the embodiments described herein, efficient string search techniques for packet payloads are disclosed that support line-rate packet forwarding speeds. The embodiments employ CAM (Content Addressable Memory)-based comparision schemes, wherein selected sub-string portions of one or more search strings are hashed, with the resulting hash values being stored as entries in a CAM. During packet payload searching, sub-string portions of the payload are hashed, with the result of each hash compared against CAM entries. If there is a CAM “hit” (e.g., a current hash result matches one of the CAM entries), there is a possibility that the entire search string is present in the payload. Subsequent full string (e.g., byte-by-byte) comparisons of the search and payload strings are then made to verify whether the CAM hit is a true or false search string hit. Meanwhile, the absence of a CAM hit indicates none of the search strings are present in the payload.

Under a typical implementation, a set of one or more (N) strings will be searched for in packet payloads in connection with packet forwarding operations. The set of all search strings is represented as S={S₁, S₂, . . . , S_{N}}. Let L₁, L₂, . . . , L_{N} represent the respective lengths of strings S₁, S₂, . . . , S_{N}. Furthermore, note that the given set of strings may have different lengths and a given string may be located at any offset within a packet payload being searched.

Under a conventional string search approach, a sequence of bytes in the data object being searched (e.g., a packet payload in the examples discussed below) are compared with a pre-defined sequence of bytes representing the search string. This process, while accurate, may be very time consuming, especially when longer strings are being searched for. Furthermore, the techniques may require significant amounts of scratch memory (e.g., memory used for temporary usage during the string comparison operations).

In accordance with one aspect of the embodiments disclosed herein, a hashing scheme is employed to provide efficient string searches. Through hashing, a long sequence of bytes can be converted to a smaller value, which is much easier to compare to a pre-stored hash result derived from a corresponding hash key. Furthermore, the embodiments employ a CAM-based comparison scheme, wherein hash results derived from search strings of interest are stored in a CAM. Rather then performing a byte-by-byte comparison, the CAM-based scheme enables a given input hash result to be compared with all of the hash value entries stored in the CAM in parallel. The combination of employing hashing techniques and CAM-based data comparisons results in a very efficient string search mechanism that supports line-rate speeds.

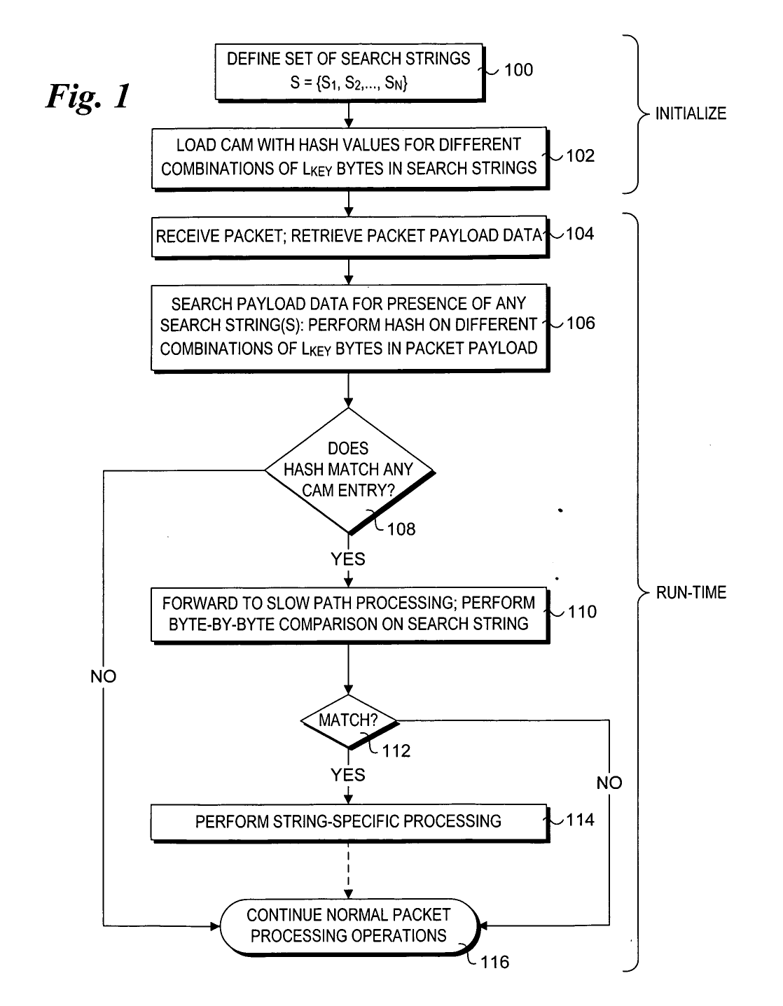

A flowchart illustrating an overall string search and handling process in accordance with one embodiment is shown in FIG. 1. The first two operations in blocks 100 and 102 represent initialization operations, which are performed prior to the subsequent run-time operations depicted in FIG. 1. First, in block 100, the set of search strings S is defined. For example, if an Internet worm or virus is to be searched for, S may include a binary sub-string corresponding to a selected portion of the executable file for a known worm or virus. In general, the set S will include one or more search strings.

Next, in block 102, hash values are derived from the search strings and loaded into a CAM. In further detail, for each string in S, different sub-string combinations of L_{key} bytes for each search string are hashed, where L_{key} represents the length of the hash keys. The resulting hash values are then stored in the CAM. Generally, the hash values may be loaded into the CAM during initialization of a network processor, or may be loaded into the CAM during ongoing network processor operations (i.e., at run-time).

The remaining run-time operations depicted in FIG. 1 are performed on a continuous basis in response to receipt of new packets at a network device or the like. The run-time process begins with receipt of a packet in a block 104. In response, normal packet processing operations are performed, such as extracting the metadata (e.g., packet header data) and storing the packet payload data in memory. All or a portion of the packet payload data is then retrieved into local memory for local access by a compute engine.

In a block 106, the packet payload data is searched for the presence of any search string in S. During this operation, hash keys comprising different sequential combinations of L_{key} bytes (e.g., sub-strings) are taken from the payload data, and a corresponding hash result is calculated by performing a hash on each hash key. For each hash key, the result is then simultaneously compared with all entries in the CAM. The determination of whether there is a match between the hash results for a packet payload and any of the CAM entries is depicted by a decision block 108. A NO determination by block 108 results if there is not a match (no CAM hit). This further indicates the absence of any string of S in the payload. Accordingly, the process is advanced to a continuation block 116, wherein normal packet processing operations are continued.

If there is a hit, there is a possibility of one of the strings from set S occurring in the payload. Once a hit is identified, a full string search of the payload is made to verify whether the hit was a false hit or any of the strings from set S are present in the payload (a true hit). The full string search is needed for several reasons. First, the hash values stored in the CAM are derived from sub-string combinations of L_{key} bytes and not an entire search string. Thus, a CAM hit only indicates that a matching portion of the search string might exist in the payload. Second, matching hash values do not necessarily imply matching strings (sub-strings in this instance). Although hashing is a good way to identify string matches, it isn't perfect. It is possible for dissimilar hash keys (e.g., the sub-strings being compared) to produce the same hash result.

In one embodiment, a byte-by-byte comparison is used to positively identify the presence of a search string in the payload data. However, as discussed above, byte-by-byte comparisons may consume significant amounts of time (relative to line-rate speeds), and thus are too slow to be performed at line rates. In one embodiment, this is handled by forwarding handling of a packet corresponding to a CAM hit to a slow processing path, which is used to perform a byte-by-byte comparison of the packet payload data against any applicable search strings identified by the CAM hit.

In further detail, modern network processors are able to support high line-rates by providing two levels of packet processing: fast path and slow path. Fast path processing is performed at line-rate speeds, and is used to handle processing of most packets. In some architectures, fast path operations are performed in the “data plane,” while “slow” path operations are performed in the “control plane.” Slow path processing is generally used for exception handling and other considerations, such as for packets that are destined for the network device hosting the network process (and thus do not need to be forwarded). Whether a packet is handled via the fast or slow path is usually determined by the network processor and/or other components in the network device. For example, if the network processor determines handling of a packet will exceed the Maximum Transmission Unit (MTU) of a particular process, that packet is assigned to the slow path.

As depicted by a decision block 112, during the byte-by-byte comparison, a determination is made to whether a matching search string is found in the payload data. If there is no match, processing of the packet is continued in the normal manner, as depicted by continuation block 116. If there is a match, string-specific handling of the packet is performed in a block 114. For example, if the string relates to a virus or worm, the string-specific handling may drop the packet and send information to instruct the network device (as well as other network devices, potentially) to drop packets containing similar packet metadata. Other information could be provided to not resend the packet or to otherwise block packets from being sent from the same source address. Similarly, if the search string is used for billing purposes, the operations performed in block 114 may relate to a billing process.

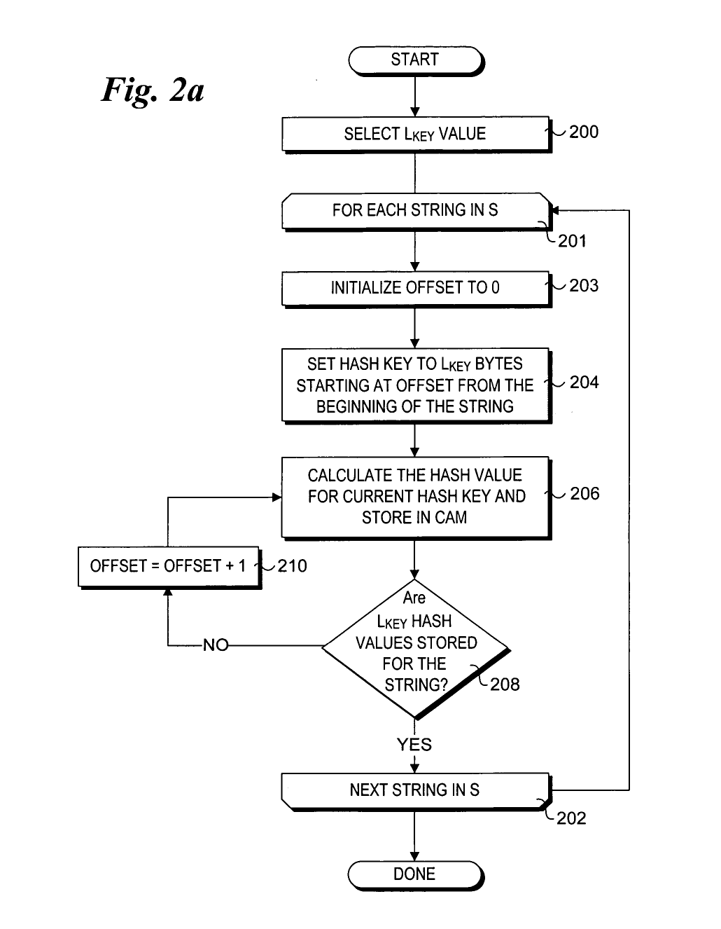

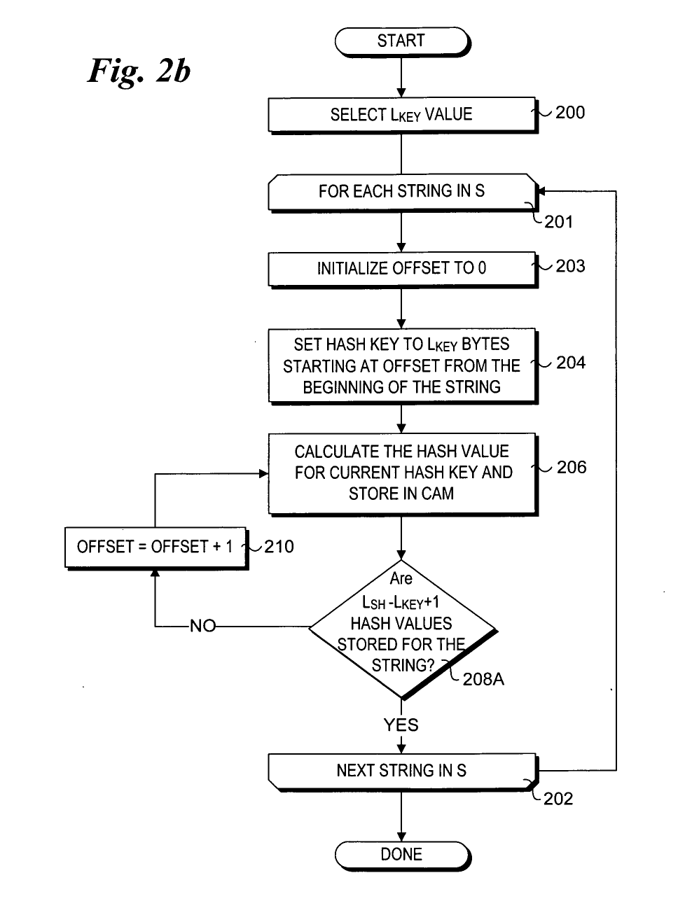

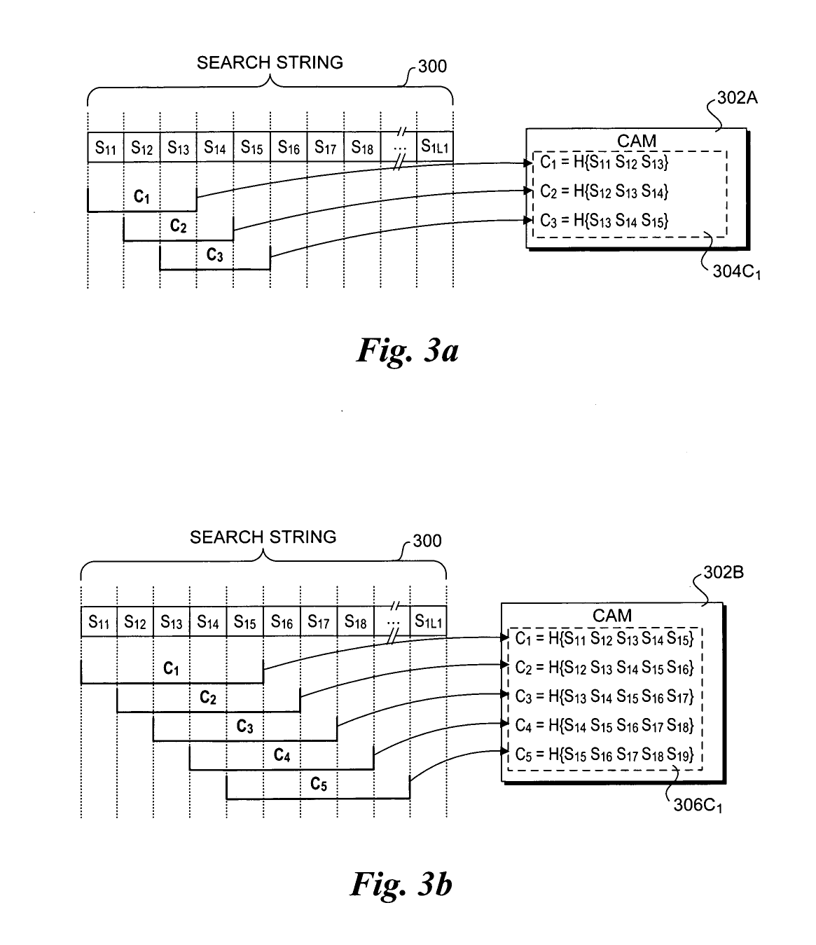

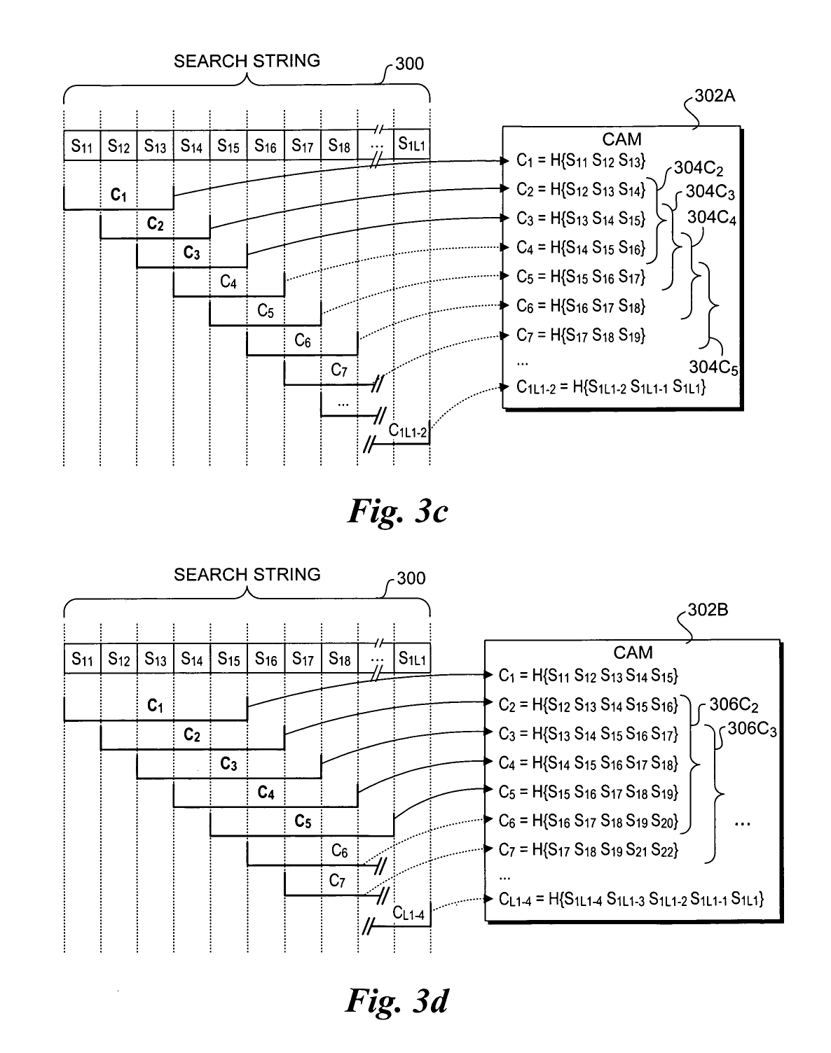

Details of one embodiment of the initialization operation of blocks 100 and 102 are shown in FIGS. 2a, 3a, and 3b. As discussed above, the first operation is to identify the strings to be searched. For illustrative purposes, the strings in set S={S₁, S₂, . . . , S_{N}} are represented in the figures herein as follows:
S₁=s₁₁s₁₂s₁₃ . . . s_{1L1}.
S₂=s₂₁s₂₂s₂₃ . . . s_{2L2}.
S_{N}=s_{N1}s_{N2}s_{N3} . . . s_{NLN}.

Under this nomenclature, the first subscript value identifies the string, while the second subscript value identifies the position of a byte within the string. The subscript values for the last entry in each string identify the length of that string. For example, the subscript “1L1” indicates the length of string 1 is L1 bytes.

After the set of search strings is defined, selected sub-string combinations of sequential bytes in the search strings are hashed and stored in the CAM. An exemplary generic search string 300 is shown in FIGS. 3a-d. In one embodiment, the selected combinations comprise L_{key} bytes having starting points (i.e., first bytes) that are offset by one byte each (and thus have overlaps of L_{key}−1 bytes). In the embodiments illustrated in FIGS. 3a and 3b, the L_{key} byte sub-string combinations begin at the start of search string 300, and are generated in accordance with the flowchart of FIG. 2a.

The process begins in a block 200, wherein an L_{key} value representing the length in bytes of the hash keys for which hashing is performed is selected. In general, the length of the hash keys will be somewhat related to the length of the search string. However, other considerations may also influence the selected L_{key} value. The operations defined by start and end loop blocks 201 and 202 are then performed for each search string in S, as follows.

The first operation for a given string is to initialize an offset value (the offset from the start of the search string) to zero, as shown in a block 203. Next, in a block 204, the length of the current hash key is set to L_{key} bytes, beginning from the start of the string (e.g., offset=0).

The operations in block 206, decision block 208, and block 210 are performed in a loop to generate L_{key} CAM entries. First, in block 206, a hash value is calculated for the current hash key. For example, in FIG. 3a L_{key} is 3, and the values of bytes s₁₁, s₁₂, and s₁₃ are hashed to produce a CAM entry C₁. The particular hash function that is employed is left to the designer. It may be a very simple hash, such as a mod(ulus) function, or a more sophisticated hash function, such as that employed by one of many well-know hash algorithms (e.g., MD4, MD5, the SHA-1 (secure hash algorithm)-1 hash algorithm, etc.)

In one embodiment, L_{key} entries derived from hash keys having starting points offset by one byte are stored in the CAM. As illustrated in the figures discussed below, L_{key} entries derived from offset and overlapping sub-strings having a length of L_{key} is the minimum number of entries need to guarantee a CAM hit for a matching string. Accordingly, a determination is made in decision block 208 to whether there have been L_{key} entries generated for the current string. If not, the process proceeds to block 210, wherein the offset is incremented by one. The process then loops back to block 206 to generate the next hash key value, with the operations of blocks 206 and 210 being repeated until L_{key} CAM entries are generated.

FIG. 3a shows a CAM 302A including three CAM entries C₁₋₃. As depicted by the dashed box 304C₁, the minimum number of CAM entries is equal to L_{key}, which is 3 in this instance. Thus, the operations of the flowchart of FIG. 2a will generate three CAM entries C₁, C₂, and C₃. Meanwhile, in the embodiment illustrated in FIG. 3b, L_{key}=5. Thus, the FIG.-2a operations will generate five hash results to be stored as entries C₁₋₅ in a CAM 302B, as depicted by a dashed box 306C₁.

In addition to the minimum number of entries contained in dashed boxes 304C₁ and 306C₁, each of CAMs 302A and 302B show further entries in FIGS. 3c and 3d. These are depicted to show optional combinations of entries that may be stored in the CAM. For example, while the first L_{key} entries beginning with the start of a search string are produced using the operations of FIG. 2a, this is not meant to be limiting. The L_{key} entries can begin at an offset anywhere within the search string, as long as the L_{key} bytes of the last entry fall within the search string, as exemplified by CAM entry sets 304C₂₋₅ in FIG. 3c and CAM entry sets 306C₂₋₃ in FIG. 3d. There may be situations under which it is advantageous to not begin at the start of the search string. For example, if the search string comprises an ASCII string of characters, and any combination of L_{key} sequential characters near the start of the string represent a common word, it may be advantageous to begin at an offset other than zero so that a hash key used to produce a CAM entry does not correspond to a common word.

The maximum length of L_{key} is dependent on the length of the shortest string in S (L_{SHORTEST}), as defined to by:
L_{SHORTEST}≧2L_{KEY}−1 (1).
In order to guarantee that a search string present in a packet payload will be found, Equation 1 must be met.

The CAM entries in CAMs 302A and 302B are illustrative of CAM entries that might be generated for a given string. As discussed above, similar sets of CAM entries would be generated for each string in S. For clarity, these additional sets of CAM entries are not depicted herein so as to not obscure the operation of the searching phase, which is now discussed.

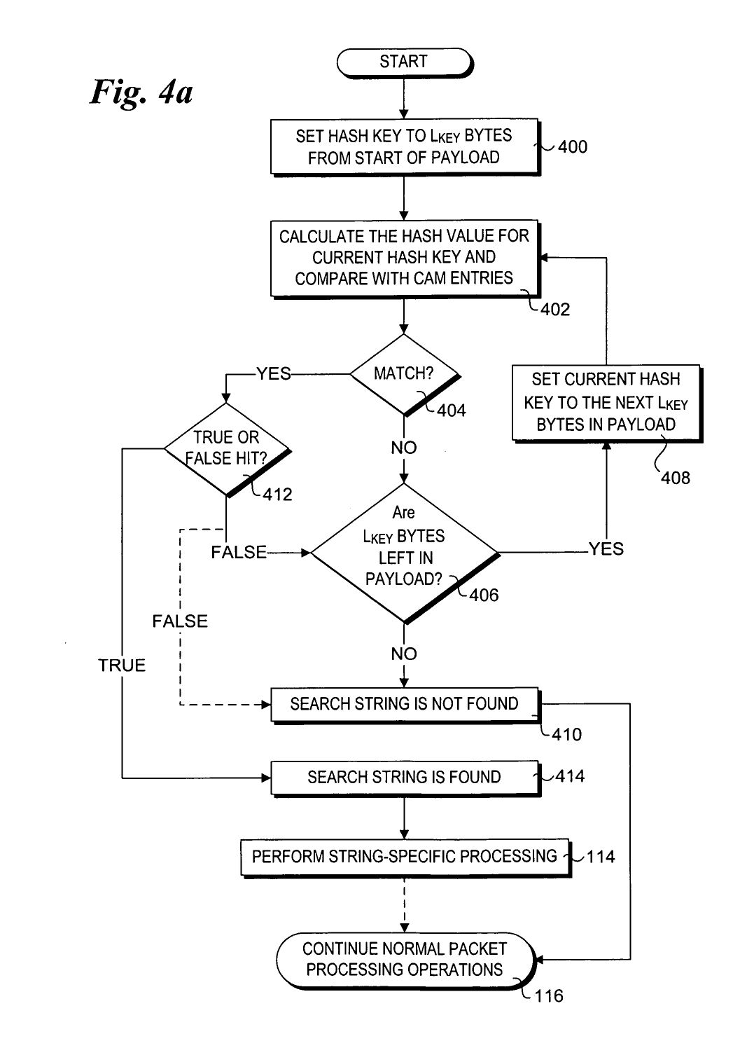

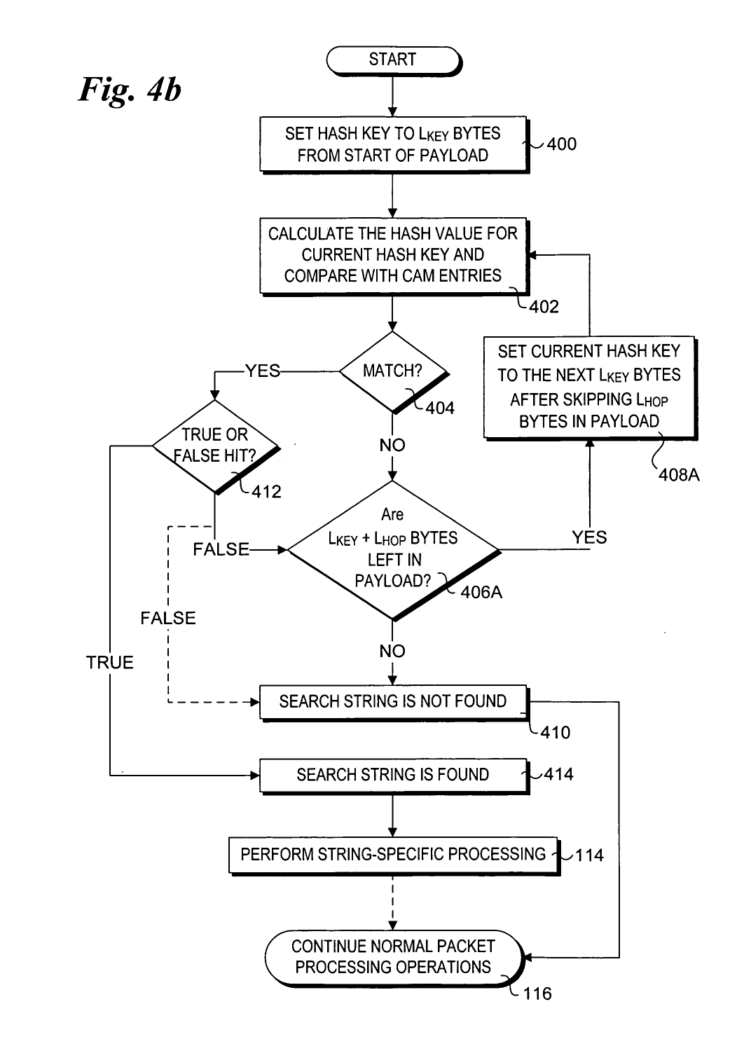

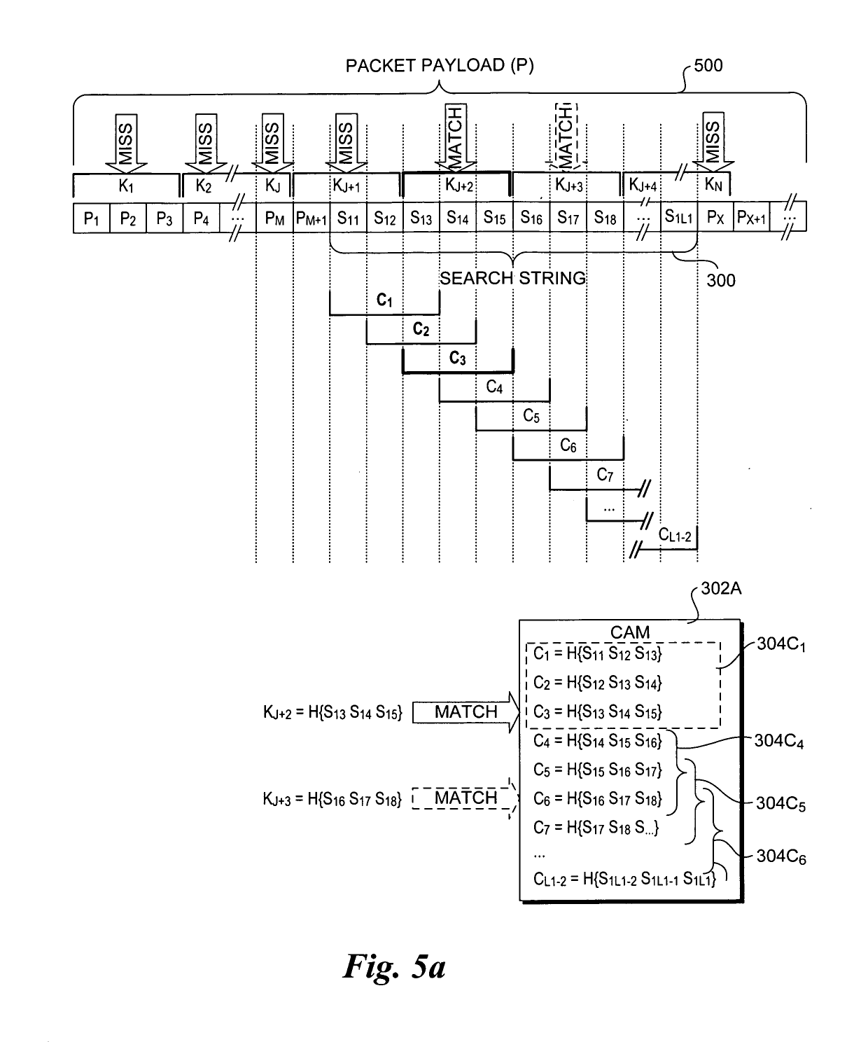

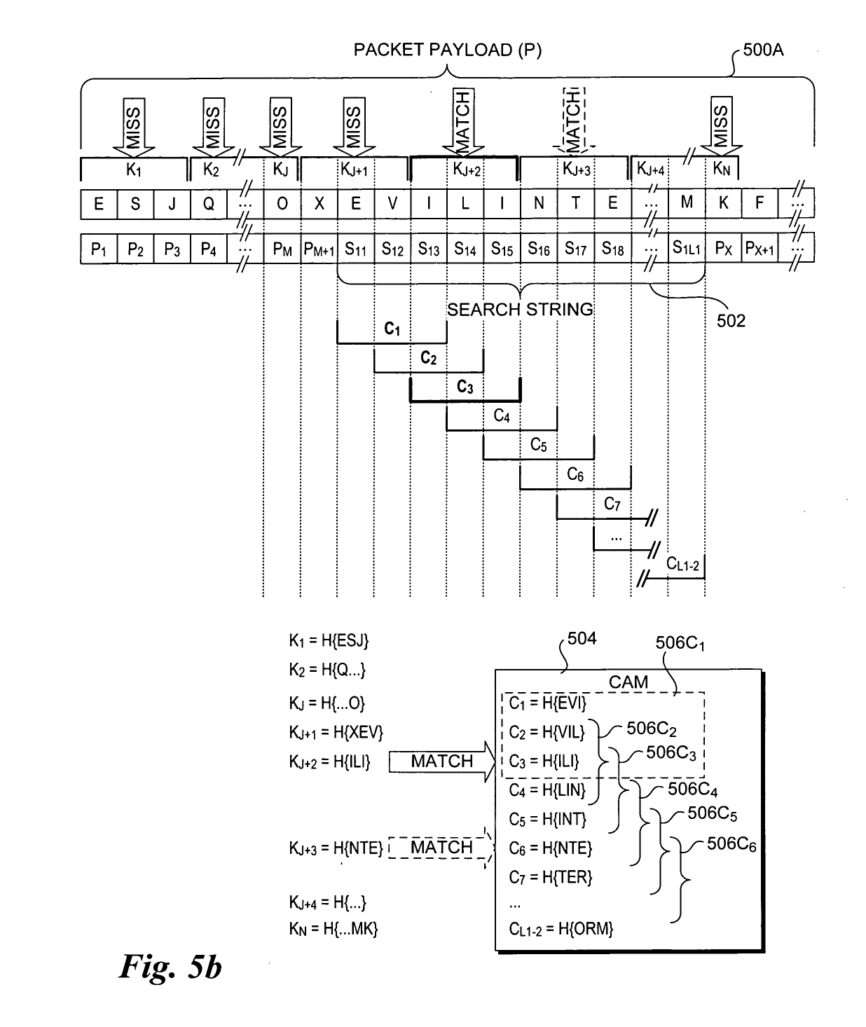

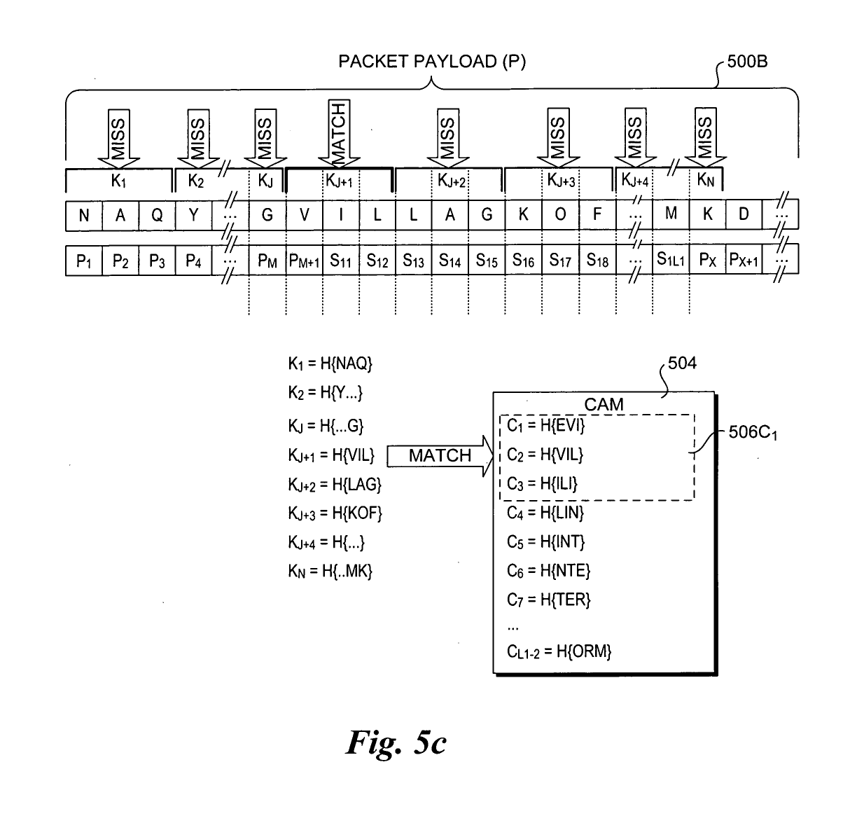

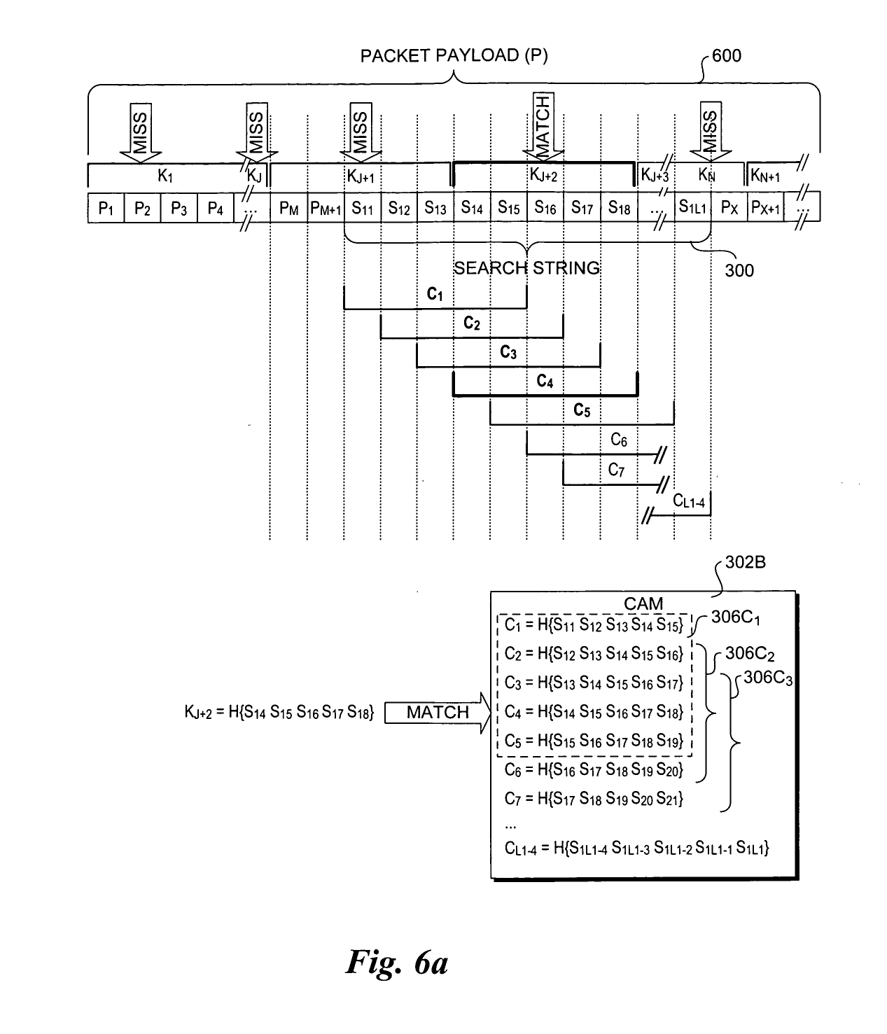

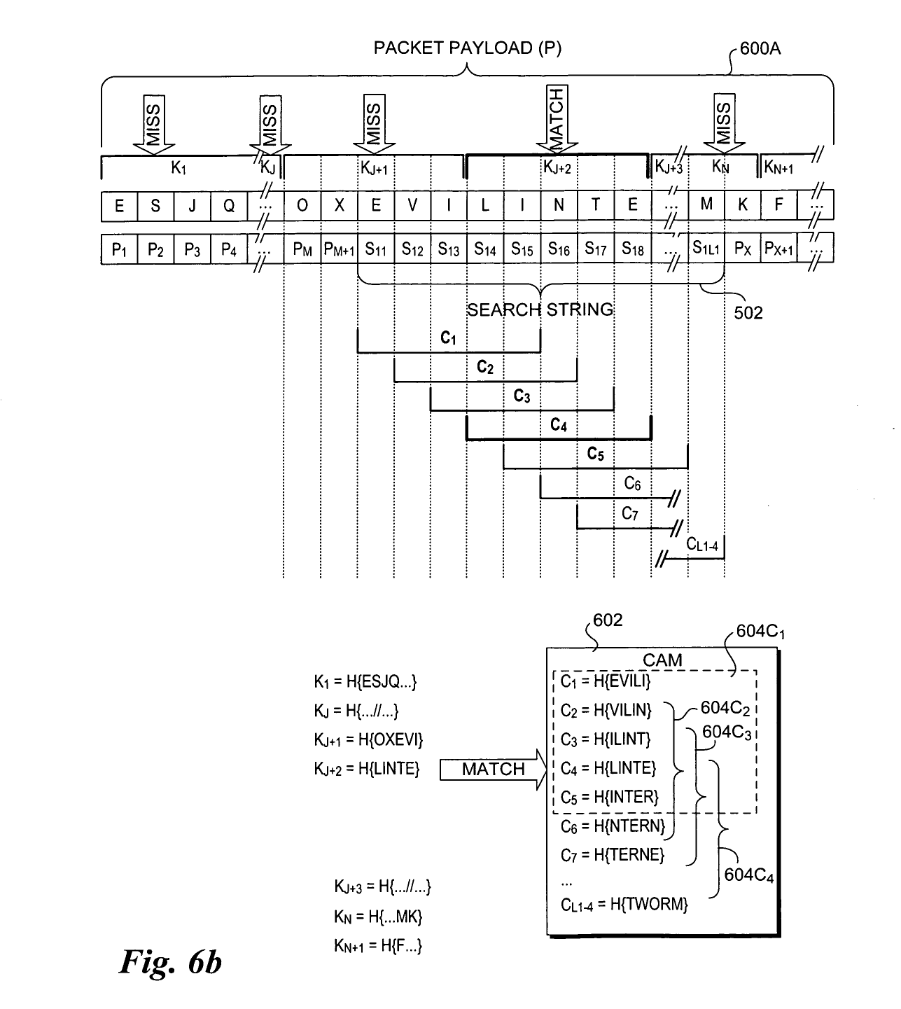

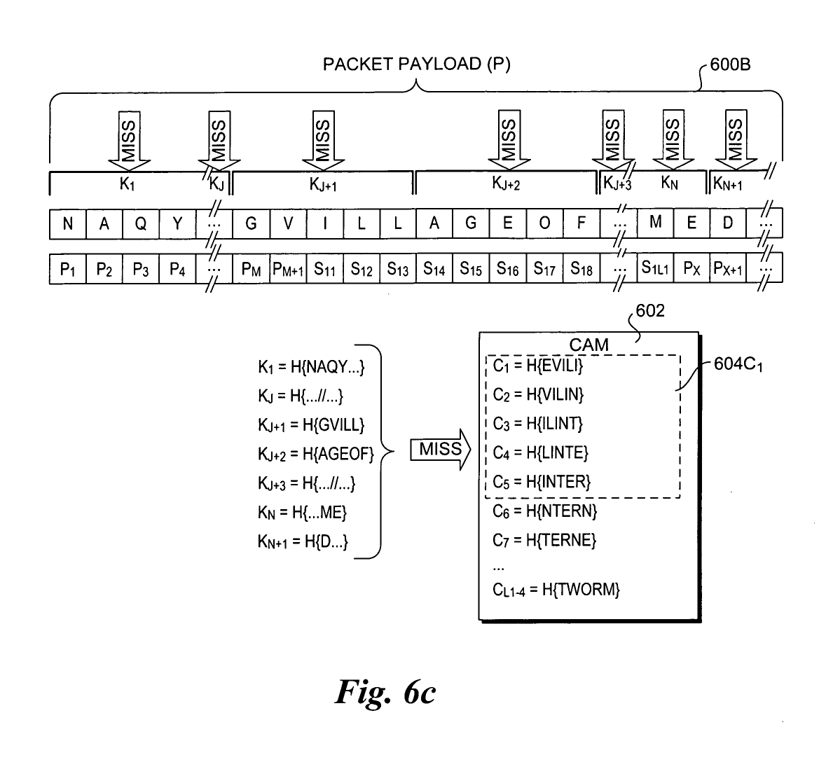

With reference to the flowchart of FIG. 4a and FIGS. 5a and 6a, the search process, according to one embodiment, proceeds in the following manner. In a block 400, a hash result calculated from a hash key comprising the first L_{key} bytes in the payload is generated. For example, similar packet payloads 500 and 600 are shown in FIGS. 5a and 6a, respectively. The nomenclature P₁, P₂, P₃ . . . depicts the position of a given byte in the payload. Each of packet payloads 500 and 600 include a search string 300 comprising the byte sequence depicted in FIGS. 3a and 3b. In general, a searched-for string may be located anywhere within a packet payload. Therefore, the search scheme must be flexible to identify whether any of the search strings in set S are present in the payload, regardless of location.

In a block 402, the hash value for the current hash key is calculated and compared with the hash key entries stored in the CAM. In FIG. 5a, the value for L_{key} is 3, while the value for L_{key} is 5 in FIG. 6a. Accordingly, the first hash result is derived by derived by hashing the first three bytes of packet payload 500 (hash key K₁) using the same hash function that was used to generate the CAM entries in CAM 302A, while the first hash key K₁ for packet payload 600 (comprising the first five bytes of that payload) is hashed to produce the first hash result for the example of FIG. 6a.

In a decision block 404, a determination is made to whether the hash result generated in block 402 matches any values in the CAM. If there is not a match, the logic proceeds to a decision block 406 in which a determination is made to whether they are at least L_{key} bytes left in the payload. If the answer is YES, the logic proceeds to a block 408 in which the current hash key is set to the next L_{key} bytes in the payload, whereupon the process loops back to block 402 to evaluate this new hash key. The operation of blocks 402, 404, 406, and 408 are continued in a loop-wise manner until either the result of decision block 404 is YES or the result of decision block 406 is NO, indicating the end of the packet payload has been reached. If the end of the packet payload is reached without a match, there are no search strings present in the packet payload, as depicted by a block 410. The process then proceeds to continuation block 116 to continue normal packet processing operations.

For the purpose of illustration it is presumed that each of hash keys prior to the start of search string 300 (e.g., K₁, K₂, . . . K_{J}) in FIG. 5a produce a miss (i.e., there is no match). The next hash key to compare is K_{J+1}, which includes the last byte before the start of search string 300 and the first two bytes of the search string. This likewise is presumed to produce a miss. The following hash key K_{J+2} includes bytes s₁₃, s₁₄, and s₁₅. This is the same byte sequence from which CAM entry C₃ was derived. Accordingly, the comparison in decision block 404 returns a match (YES), and the logic proceeds to a decision block 412 to determine whether the match corresponds to a true or false hit. As discusses above with reference to FIG. 1, in one embodiment this is determined by forwarding the process to the slow path processing and performing a byte-by-byte comparison on the string of interest. In one embodiment, information is maintained in the network processor that maps CAM entries to corresponding search strings. In this instance, a byte-by-byte comparison is made against a particular search string. In another embodiment, a match will cause the logic to proceed to decision block 412 without indicating which search string yielded a hash key match. In this case, a byte-by-byte comparison with all of the search strings (one at a time) is performed until a match is found or all of the search strings have been evaluated and no match is found.

In the case of a specific search string (out of multiple possible search strings), a false hit causes the logic to return to decision block 406. In the case of a non-specified search string, a false hit (evaluated over all of the search strings) will cause the logic to proceed to block 410, indicating that none of the search strings are present in the packet payload.

If the hit is determined to be TRUE, the logic proceeds to a block 414, which is included here to indicate that the search string was found. Accordingly, a string-specific handling process is performed in block 114 in the manner discussed above. Depending on what the handling process is designed to do, further processing may continue, as depicted by the dashed flow arrow to continuation block 116, or processing of the packet may be complete at this point.

The embodiment of FIG. 6a proceeds in a manner analogous to that shown in FIG. 5a and discussed above, except in this case the value of L_{key} is set to 5. This produces a match for hash key K_{J+2}, which corresponds to CAM entry C₄ in CAM 302B. In addition to producing a match with the first set of CAM entries 306C₁, each of CAM entries sets 306C₂ and 306C₃ would also yield a match. As before, all of the evaluations for hash keys K₁ through K_{J+1} produce misses.

FIG. 5a also illustrates a potential additional match condition (depicted by the MATCH arrow with dashed lines). This is to show potential matches that might occur if the given set of entries in a CAM include the additional entries discussed above with reference to FIGS. 3c and 3d (e.g., the sets of L_{key} entries outside of dashed boxes 304C₁ and 306C₁, such as any of CAM entry sets 304C₄₋₆ in FIG. 5a).

The search strings and corresponding search results illustrated in FIGS. 5a and 6a illustrate generic search strings. Results for specific search strings are shown in FIGS. 5b-c and 6b-c. In these instances, the search string 502 being searched for in packet payloads 500A and 600A is “EVILINTERNETWORM”, which corresponding CAM entries being stored in CAMs 504 and 602. For illustrative purposes, each byte shown in the packet payloads represents a corresponding ASCII 8-bit character.

As shown in FIG. 5b, each of hash key K_{J+2} and CAM entry C₃ are obtained by hashing the character sub-string “1L1”, thus producing a match. An additional match might also occur for hash key K_{J+3} and CAM entry C₆, which are generated by hashing the character sub-string “NTE”. Thus, any of CAM entry sets 506C₁₋₆ would produce a match. Similarly, as shown in FIG. 6b, hash key K_{J+2} and CAM entry C₄ are obtained by hashing the character sub-string “LINTE”, thus producing a match. Accordingly, any of CAM entry sets 604C₁₋₄ would produce a match.

FIG. 5c illustrates an example of a false hit using a 3-byte value for L_{key}, while no match condition at the CAM level is detected on the same packet payload using the 5-byte value for L_{key} shown in FIG. 6c. In FIG. 5c, the CAM entries for CAM 504 are the same as shown in FIG. 5b. During hash key comparisons, a match is determined for hash key K_{J+1} (with CAM entry C₂), with each of the hashes derived from sub-string “VIL”. However, this is a false hit, as the embedded string depicted in packet payload 500B is “VILLAGEOFTHEDAMNED” (partially not shown), which doesn't match the search string “EVILINTERNETWORM). This false hit would be determined during the byte-by-byte comparison.

Now consider the same packet payload 600B using the 5-byte L_{key} hash scheme of FIG. 6c. In this instance there are no matches between the hash results for the packet payload hash keys and the CAM entries in CAM 602. This illustrates the value of using a longer L_{key} value. However, as discussed above, longer L_{key} values result in slower hashes (generally) and require greater CAM storage space.

Faster Search Scheme

The basic scheme disclosed above requires a minimum of L_{key} entries in the CAM for each string in S (without considering the possibility of duplicate entries). If the CAM memory complexity is increased to O(L_{SHORTEST}), the payload search can be made faster by skipping a predetermined number of bytes between L_{key} byte sub-strings rather than having to consider every sequential L_{key} byte sub-string.

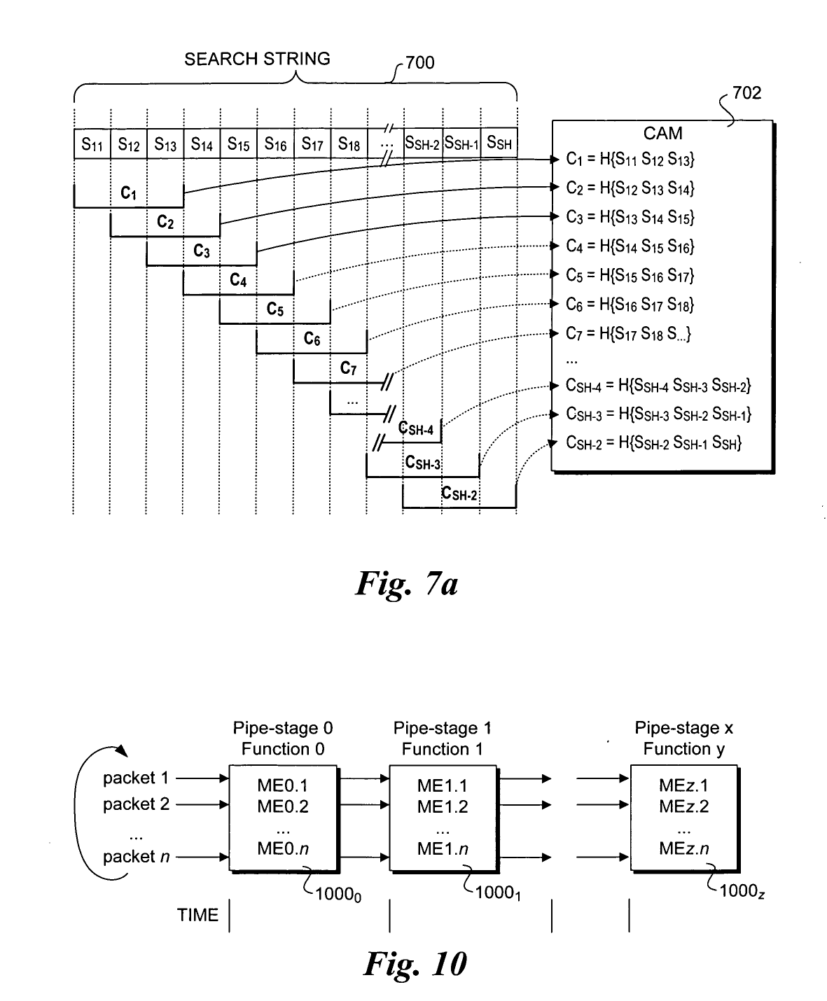

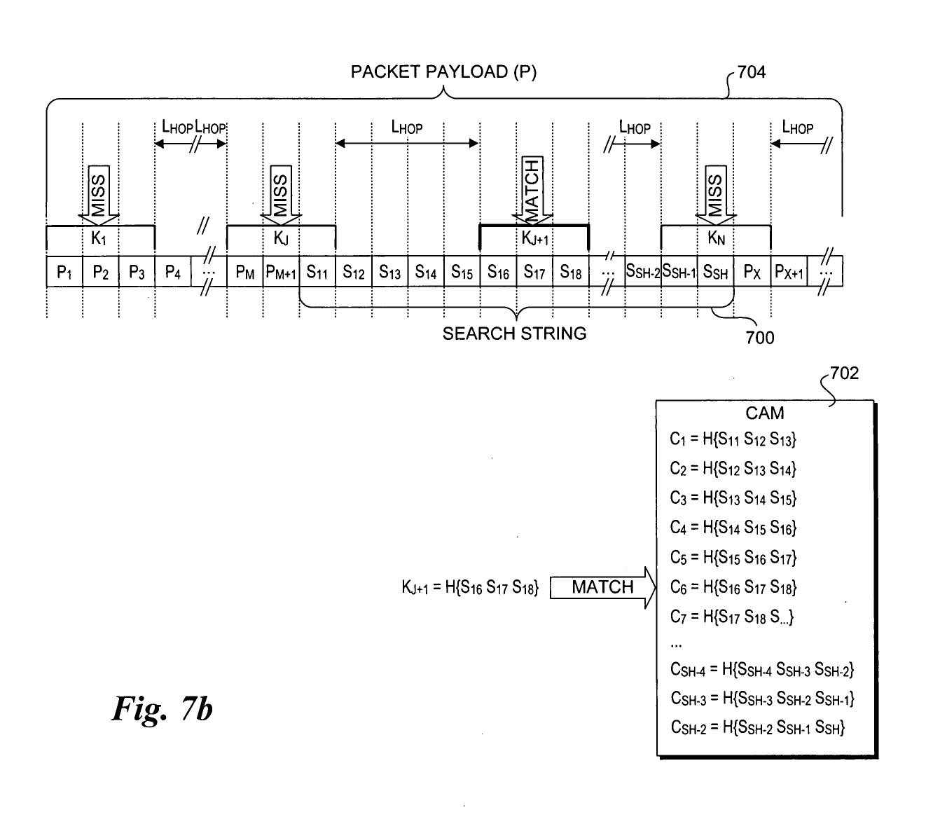

With reference to FIG. 2b, the operations for generating the hash value entries stored in the CAM are similar to that discussed above in FIG. 2a, wherein like-numbered blocks in FIGS. 2a and 2b perform similar operations. However, in this instance, the number of hash values stored in the CAM is L_{SHORTEST}−L_{KEY}+1, as depicted in a decision block 208A. An exemplary set of CAM hash value entries generated for a search string 700 using the process of FIG. 2b is shown in FIG. 7a. The CAM hash value entries C₁ through C_{SH-2} are calculated from 3-byte hash keys contained in search string 700 and stored in a CAM 702.

An example of performing a string search on a packet payload 704 using the skipping technique is shown in FIG. 7b, while a flowchart illustrating the operations and logic for performing the technique is shown in FIG. 4b. The packet payload search process begins in the same manner as above, wherein a hash is performed on a hash key K₁, which is a sub-string comprising the first L_{KEY} bytes of packet payload 704. For purpose of illustration, it will be assumed that the hash result does not match any of the entries in CAM 702. However, instead of taking the next L_{KEY} bytes as the next hash key, an L_{HOP} number of bytes are skipped to locate the start of the next hash key, as depicted in a block 408A of FIG. 4b. This process is repeated until we reach hash key K_{J}. This hash key overlaps a portion of search string 700; however, there still is no match, as a complete overlap doesn't exist. Thus, the process loops back to block 408A, and another L_{HOP} bytes of the payload are skipped to locate the start of hash key K_{J+1}. The hash result for hash key K_{J+1} produces a match (with CAM entry C₆), thus producing a CAM hit. Accordingly, subsequent byte-by-byte string comparison operations are then performed in the slow path to verify whether or not the entirety of search string 700 is present in packet payload 704.

Under the foregoing scheme, L_{HOP} is selected so as to produce the largest hop (number of bytes skipped) while still guaranteeing that a hash key will fall completely within the set of CAM entries that are stored. The L_{HOP} can be chosen in such a way that, when there is a maximum overlap of a non-matching hash key and the search string, the next set of bytes chosen as the next hash key fall completely within the string. In one respect, the basic search scheme discussed above is a special case of the faster search scheme, wherein L_{HOP}=0. The maximum hop size can be determined by the following equation:
L_{HOP(max)}=L_{SHORTEST}−2*L_{KEY}+1 (2)
Optimizations

The discussion of the faster search algorithm presented above states there are L_{SHORTEST}−L_{KEY}+1 CAM entries for each string in set S. However, this figure merely represents the upper limit on the number of CAM entries per string. Depending on the particular search strings and their corresponding hash keys, the actual number of CAM entries that are needed may be reduced.

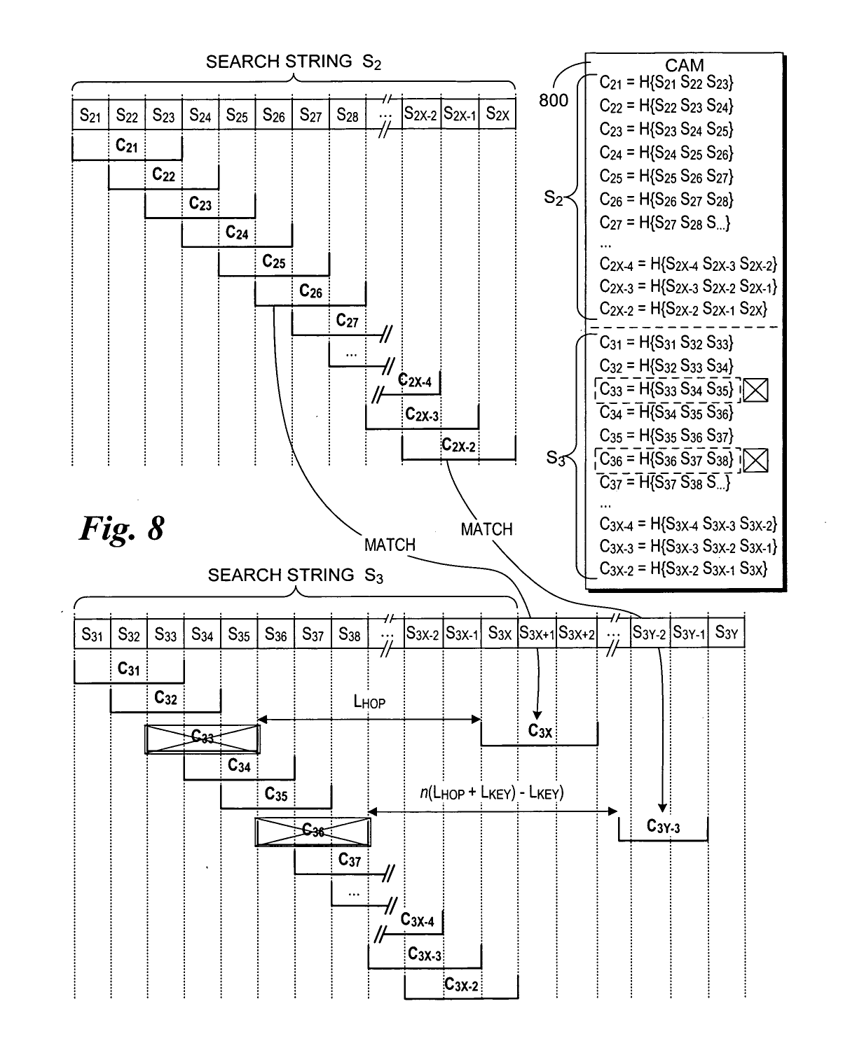

Let us considerer two arbitrarily chosen strings S₂ and S₃ from set S, wherein X is the length of S₂ and Y is the length of S₃, where Y>X. These strings are schematically illustrated in FIG. 8. The algorithm shown in FIG. 2b adds L_{SHORTEST}−L_{KEY+1} CAM entries for each of strings S₂ and S₃ by choosing sub-strings comprising L_{KEY} consecutive bytes to form the hash keys starting with the first byte and then advancing the “window” one byte at a time, as shown in a CAM 800 in FIG. 8.

Under one embodiment, the remaining sub-strings of L_{KEY} bytes for the string are compared with the hash keys for the existing CAM entries. If there is a match, the CAM entry that is offset by n(L_{HOP}+L_{KEY})−L_{KEY} bytes (number of bytes skipped depicted in FIG. 8), wherein n is an integer>0. In this instance, the term “offset” represents the distance (number of bytes) between the end of a given hash key and the start of the matching hash key. For example, if n=1, a hash key offset by L_{HOP} of the matching hash key may be removed, as depicted by CAM entry C₃₃ in FIG. 8. The reason this will work is that if a packet payload search was to consider a hash key corresponding to a removed CAM entry, one of the subsequent hops (e.g., the next hop when n=1, second hop when n=2, etc.) for the search will land on another CAM entry, generating a CAM hit.

Another optimization relates to adjustment of the “effective” size of the shortest string. For example, under the CAM entry generation scheme of FIG. 2b, the number of CAM entries for the shortest string will be L_{SHORTEST}−L_{KEY}+1. This can be lowered by an arbitrary amount by reducing the value of L_{SHORTEST} such that it is less than the length of the shortest string. (It is noted that L_{SHORTEST} must still satisfy Equation 1.) As provided by the maximum hop size defined in Equation 2, a reduction in L_{SHORTEST} will also result in a reduction in the maximum hop L_{HOP(max)}. Thus, the determination of an optimum size for L_{SHORTEST} will involve some tradeoff between CAM requirements and the hop size.

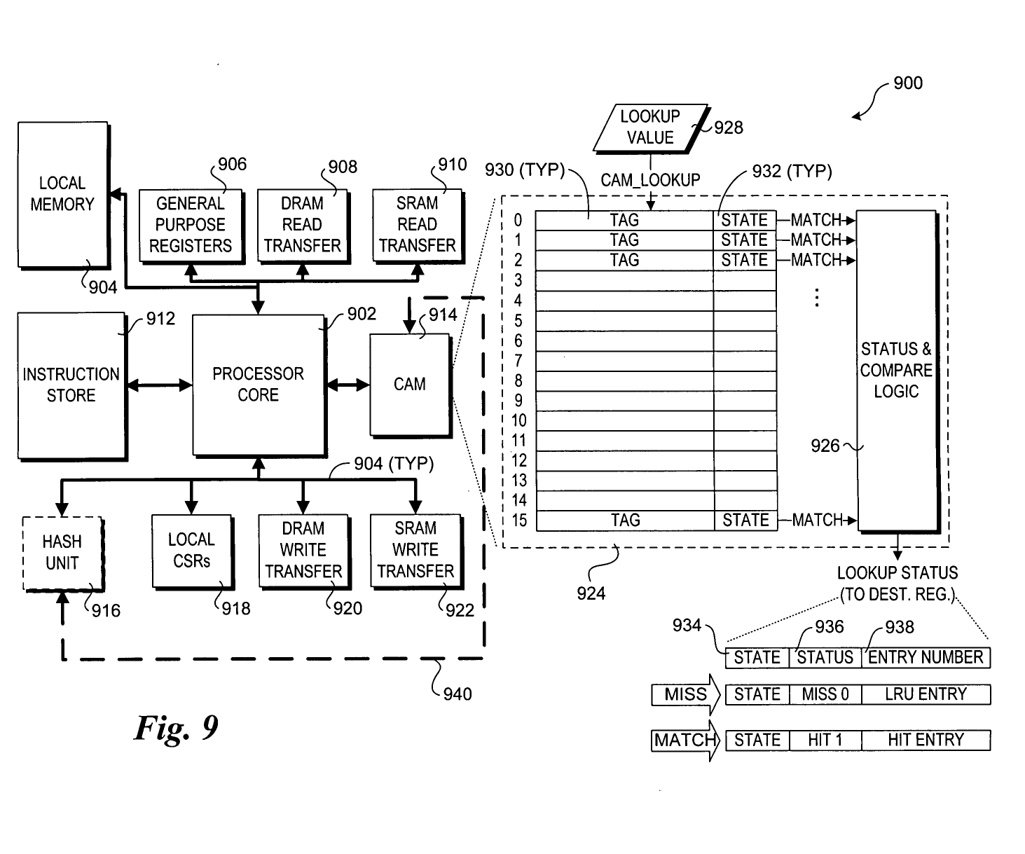

FIG. 9 shows one embodiment of a microengine 900 that may be employed for performing the string search operations described herein. At the heart of microengine 900 is a processor core 902. The processor core includes the functional units to perform processor operations such as shift, add, subtract, multiple, etc. Processor core 902 is connected to various components via appropriate data and control buses, which are depicted as individual connectors 904 for clarity. These components include local memory 904, general-purpose registers 906, a DRAM read transfer registers 908, a SRAM read transfer registers 910, an instruction store 912, a CAM 914, an optional hash unit 916, local control and status registers (CSRs) 918, a DRAM write transfer registers 920, and an SRAM transfer registers 922.

Further details of CAM 914 are depicted toward the right side of FIG. 9. The CAM includes a memory array 924 in which multiple CAM entries are stored. In the illustrated embodiment, memory array 924 includes 16 entries; however, this is merely exemplary, as the number of entries supported by the CAM will depend on the targeted usage for the CAM. The memory array 924 is coupled to status and compare logic 926, which is used to control CAM operations and produce output data in response to comparing a lookup value 928 provide to the CAM's input port. In the illustrated embodiment, each CAM entry includes a tag field 930 and a state field 932. In one embodiment, tag field 930 is a 32-bit field, while state field 932 is a 4-bit field. Other field widths may also be employed.

A CAM functions as an associative cache array, wherein the values in tag field 930 comprise the actual data to be searched from, hence the name “content addressable memory.” In response to an input lookup value presented at the CAM's input register (port), the CAM performs a parallel search of all its entries (via their respective tag field values) and determines whether or not a match exists. The lookup status output by status and compare logic 926 indicates whether or not a match was found, and if so, the location of the match. In one embodiment, a 9-bit return value is provided by the lookup status, and stored in an appropriate destination registers (e.g., a local CSR). The return value includes a state field 934 (matching the data in state field 932), a status bit 936, and an entry number field 938. The status bit is used to identify a CAM hit or miss. In one embodiment, the value in the entry number field 938 for a CAM miss identifies the least recently used CAM entry. In response to a CAM hit, the location of the matching CAM entry is loaded into entry number field 938.

In one embodiment, the output of hash unit 916 is operatively-coupled to the input of CAM 914, as depicted by dashed connector 940. For example, in one embodiment the hash unit includes an output register that serves an in input register to the CAM. One advantage to this architecture is that the output of hash unit 916 can be provided directly to CAM 914 without having to be passed through the datapath for processor core 902, thus saving valuable process cycles.

Modern network processors employ multiple multi-threaded processing cores (e.g., microengines) to facilitate line-rate packet processing operations. Some of the operations on packets are well-defined, with minimal interface to other functions or strict order implementation. Examples include update-of-packet-state information, such as the current address of packet data in a DRAM buffer for sequential segments of a packet, updating linked-list pointers while enqueuing/dequeuing for transmit, and policing or marking packets of a connection flow. In these cases the operations can be performed within the predefined-cycle stage budget. In contrast, difficulties may arise in keeping operations on successive packets in strict order and at the same time achieving cycle budget across many stages. A block of code performing this type of functionality is called a context pipe stage.

In a context pipeline, different functions are performed on different microengines (MEs) as time progresses, and the packet context is passed between the functions or MEs, as shown in FIG. 10. Under the illustrated configuration, z MEs 10000_{0-z} are used for packet processing operations, with each ME running n threads. Each ME constitutes a context pipe stage corresponding to a respective function executed by that ME. Cascading two or more context pipe stages constitutes a context pipeline. The name context pipeline is derived from the observation that it is the context that moves through the pipeline.

Under a context pipeline, each thread in an ME is assigned a packet, and each thread performs the same function but on different packets. As packets arrive, they are assigned to the ME threads in strict order. For example, there are eight threads typically assigned in an Intel IXP2800® ME context pipe stage. Each of the eight packets assigned to the eight threads must complete its first pipe stage within the arrival rate of all eight packets. Under the nomenclature illustrated in FIG. 1, MEi,j, i corresponds to the ith ME number, while j corresponds to the jth thread running on the ith ME.

A more advanced context pipelining technique employs interleaved phased piping. This technique interleaves multiple packets on the same thread, spaced eight packets apart. An example would be ME0.1 completing pipe-stage 0 work on packet 1, while starting pipe-stage 0 work on packet 9. Similarly, ME0.2 would be working on packet 2 and 10. In effect, 16 packets would be processed in a pipe stage at one time. Pipe-stage 0 must still advance every 8-packet arrival rates. The advantage of interleaving is that memory latency is covered by a complete 8 packet arrival rate.

Under a functional pipeline, the context remains with an ME while different functions are performed on the packet as time progresses. The ME execution time is divided into n pipe stages, and each pipe stage performs a different function. As with the context pipeline, packets are assigned to the ME threads in strict order. There is little benefit to dividing a single ME execution time into functional pipe stages. The real benefit comes from having more than one ME execute the same functional pipeline in parallel.

In view of one or more of the foregoing pipeline processing techniques, packet payload searches may be implemented while still supporting line-rate packet forwarding. In this instance, one or more threads running on one or more microengines will be employed for searching operations in accordance with the techniques disclosed herein. The software for performing the string searches will be loaded into instruction store 912 and executed as an instruction thread on processor core 902 at run-time. Prior to this, appropriate hash values (derived for the search strings) will be generated and loaded into CAM 914. The processing (latency) budget for string search operations should be selected so that line-rate processing will not be hampered for packets that do not contain strings corresponding to the strings defined for an applicable search string set. At the same time, handling of packets having matching strings are forwarded to the slow path, and thus are removed from the fast path pipeline, thus not effecting the line-rate processing.

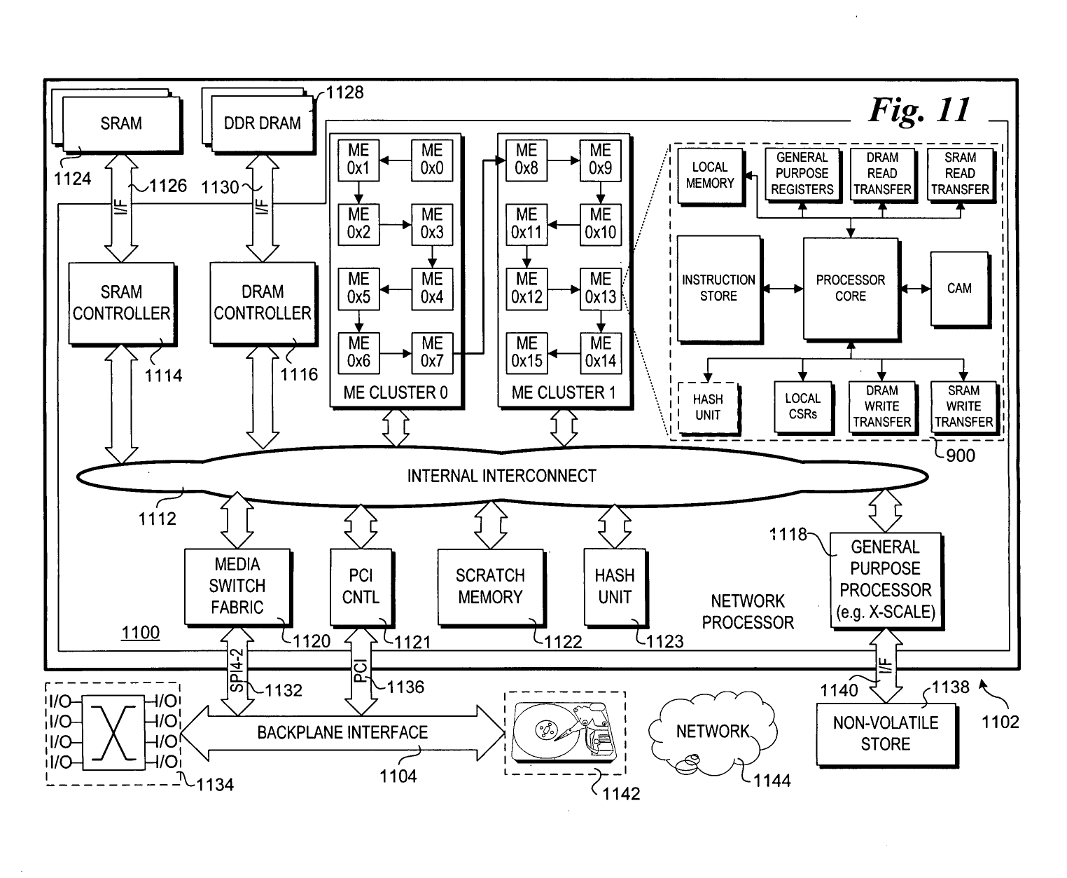

FIG. 11 shows an exemplary implementation of a network processor 1100 that employs multiple microengines 900. In this implementation, network processor 1100 is employed in a line card 1102. In general, line card 1102 is illustrative of various types of network element line cards employing standardized or proprietary architectures. For example, a typical line card of this type may comprises an Advanced Telecommunications and Computer Architecture (ATCA) modular board that is coupled to a common backplane in an ATCA chassis that may further include other ATCA modular boards. Accordingly the line card includes a set of connectors to meet with mating connectors on the backplane, as illustrated by a backplane interface 1104. In general, backplane interface 1104 supports various input/output (I/O) communication channels, as well as provides power to line card 1102. For simplicity, only selected I/O interfaces are shown in FIG. 11, although it will be understood that other I/O and power input interfaces may also exist.

Network processor 1100 includes n microengines that are configured in one or more clusters. In one embodiment, n=8, while in other embodiment n=16, 24, or 32. Other numbers of microengines may also be used. In the illustrated embodiment, 16 microengines 900 are shown grouped into two clusters of 8 microengines, including an ME cluster 0 and an ME cluster 1. In the embodiment illustrated in FIG. 11, the output from a given microengine is “forwarded” to a next microengine in a manner that supports pipelined operations. However, this is merely exemplary, as the microengines may be arranged in one of many different configurations.

In general, the microengines for network processor 1100 may have the architecture shown in FIG. 9, including a local hash unit 916, or may omit a local hash unit. Furthermore, a portion of the microengines configured for performing string search operations may include a local hash unit, while other microengines may not. Additionally, the size of the CAMs for a microengine configured for performing string search operations may be substantially larger than the CAMs used for other microengines that are not configured for performing string searches.

Each of microengine clusters 0 and 1 is connected to other network processor components via sets of bus and control lines referred to as the processor “chassis” or “chassis interconnect”. For clarity, these bus sets and control lines are depicted as an internal interconnect 1112. Also connected to the internal interconnect are an SRAM controller 1114, a DRAM controller 1116, a general-purpose processor 1118, a media switch fabric interface 1120, a PCI (peripheral component interconnect) controller 1121, scratch memory 1122, and a hash unit 1123. Other components not shown that may be provided by network processor 1100 include, but are not limited to, encryption units, a CAP (Control Status Register Access Proxy) unit, and a performance monitor.

The SRAM controller 1114 is used to access an external SRAM store 1124 via an SRAM interface 1126. Similarly, DRAM controller 1116 is used to access an external DRAM store 1128 via a DRAM interface 1130. In one embodiment, DRAM store 1128 employs DDR (double data rate) DRAM. In other embodiment DRAM store may employ Rambus DRAM (RDRAM) or reduced-latency DRAM (RLDRAM).

General-purpose processor 1118 may be employed for various network processor operations. In one embodiment, control plane (e.g., slow path) operations are facilitated by software executing on general-purpose processor 1118, while data plane (e.g., fast path) operations are primarily facilitated by instruction threads executing on the microengines.

Media switch fabric interface 1120 is used to interface with the media switch fabric for the network element in which the line card is installed. In one embodiment, media switch fabric interface 1120 employs a System Packet Level Interface 4 Phase 2 (SPI4-2) interface 1132. In general, the actual switch fabric may be hosted by one or more separate line cards, or may be built into the chassis backplane. Both of these configurations are illustrated by switch fabric 1134.

PCI controller 1122 enables the network processor to interface with one or more PCI devices that are coupled to backplane interface 1104 via a PCI interface 1136. In one embodiment, PCI interface 1136 comprises a PCI Express interface.

During initialization, coded instructions (e.g., microcode) to facilitate the packet-processing functions and operations described above, including packet payload string searching operations, are loaded into appropriate control stores for the microengines. In one embodiment, the instructions are loaded from a non-volatile store 1138 hosted by line card 1102, such as a flash memory device. Other examples of non-volatile stores include read-only memories (ROMs), programmable ROMs (PROMs), and electronically erasable PROMs (EEPROMs). In one embodiment, non-volatile store 1138 is accessed by general-purpose processor 1118 via an interface 1140. In another embodiment, non-volatile store 1138 may be accessed via an interface (not shown) coupled to internal interconnect 1112.

In addition to loading the instructions from a local (to line card 1102) store, instructions may be loaded from an external source. For example, in one embodiment, the instructions are stored on a disk drive 1142 hosted by another line card (not shown) or otherwise provided by the network element in which line card 1102 is installed. In yet another embodiment, the instructions are downloaded from a remote server or the like via a network 1144 as a carrier wave.

In one embodiment, none of the microengines includes a local hash unit 916. Rather, hash unit 1123 is shared across one or more microengines that are used for performing packet payload string searches in accordance with the embodiments described herein.

Typically, during initialization of network processor 1100 or line card 1102, various CAM entries are loaded into CAMs 914 of selected microengines 900. The CAM entries will include hash values calculated from corresponding hash key sub-strings comprising selected portions of search strings, and are generated in accordance with the techniques taught herein. Optionally, an original set, or updated CAM entries may be dynamically loaded into one or more CAMs during run-time operations.

During run-time operations, one or more threads executing on one or more microengines will be used to search for strings in the payloads of received packets using the hash key comparison techniques disclosed herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method, comprising:
performing a hash on each of a plurality of sub-string hash keys in a search string to generate respective search string hash values;
storing the search string hash values in a memory; and
determining if a data object includes the search string by,
performing a hash on each of one or more sub-strings in the data object; and
determining if a hash result from a hash on a data object sub-string matches one of the search string hash values in memory,
wherein the search string is verified to not be present in the data object if there are no matches between a hash result and the search string hash values.

2. The method of claim 1, wherein at least one of the hash results matches a search string hash value, the method further including operations performed in response thereto comprising:
performing a full search string comparison between the search string and string sequences in the data object.

3. The method of claim 2, wherein the data object comprises payload data for a network packet, and the operations for determining if the search string is included in the payload data is performed in connection with packet forwarding operations, the method further comprising:
performing payload data sub-string hash operations and determining if any corresponding hash results match one of the search string hash values in memory using pipelined fast path operations using one or more execution threads on a network processor, the fast path operations to support a line-rate speed; and
in response to detecting a match between a hash result and a search string hash value, forwarding string search operations to a slow processing path to perform the full search string comparison, the slow processing path performing packet forwarding operations at a speed less than the line rate speed.

4. The method of claim 1, wherein the memory comprises a content addressable memory (CAM) and the search string hash values stored in the CAM comprise CAM entries, the method further comprising:
performing a parallel search of a hash result against the CAM entries to determine if the hash result matches one of the search string hash values.

5. The method of claim 4, further comprising:
performing a hash on each of a plurality of sub-string hash keys for each of a plurality of search strings to generate respective sets of search string hash values for each search string;
storing the sets of search string hash values in the CAM;
storing information that maps each CAM entry to a corresponding search string; and
in response to a match with a CAM entry,
returning indicia identifying the CAM entry to which the hash result matches; and
performing a full search string comparison between the search string corresponding to the matching CAM entry and string sequences in the data object.

6. The method of claim 1, wherein the data object comprises payload data for a network packet.

7. The method of claim 6, further comprising:
in response to receiving a network packet at a network device,
storing the packet payload data in a shared memory resource for the network device; and
copying the packet payload data to a local memory resource for a compute engine for the network device; and
employing the compute engine, at least in part, to determine if a hash result from a hash on sub-string in the payload data matches one of the search string hash values in the memory.

8. The method of claim 1, further comprising:
generating search string hash values by hashing each of a plurality of hash keys comprising sub-strings of the search string having a fixed length L_{KEY}, wherein adjacent sub-strings are overlapping by L_{KEY}−1 bytes with first bytes offset by 1 byte; and
generating hash results for the data object by performing hashes on hash keys comprising non-overlapping data object sub-strings having a length of L_{KEY} in the data object.

9. The method of claim 8, further comprising:
generating L_{KEY} hash values for the search string.

10. The method of claim 8, wherein hash values are generated for each of a plurality of search strings, the shortest search string having a length L_{SHORTEST}, and wherein L_{KEY} meets the requirements of the equation:
L_{SHORTEST}≧2L_{KEY}−1

11. The method of claim 8, further comprising:
generating a set of hash values for a search string, wherein the overlapping sub-strings span the search string; and
generating hash results for the data object by performing hashes on hash keys comprising non-overlapping sub-strings having a length of L_{KEY} that are separated by an offset length of L_{HOP} bytes.

12. The method of claim 11, wherein the offset length L_{HOP} comprising a maximum hop value determined in accordance with the equation:
L_{HOP(max)}=L_{SHORTEST}−2*L_{KEY}+1

13. The method of claim 1 1, further comprising:
generating a set of hash values for each of a plurality of search strings, wherein a common number of hash values are generated for each search string based on a minimum number of overlapping sub-strings required to span a shortest search string from among the plurality of search strings;
storing a combined set of hash values in the memory comprising unique hash values included in the sets of hash value for the plurality of search strings
generating hash results for the data object by performing hashes on hash keys comprising non-overlapping sub-strings having a length of L_{KEY} that are separated by an offset length of L_{HOP} bytes; and
comparing each hash result with the hash values in the combined set of hash values to determine whether a match exists.

14. The method of claim 13, further comprising:
for each search string that is longer than the shortest search string, determining if a hash key comprising a sub-string of length L_{KEY} in the search string that was not employed to generate one of the hash values in the set of hash values for that search string matches a hash key used to generate a hash value in the combined set of hash values; and in response to finding a match,
removing a hash value in the combined set of hash values that was derived from a sub-string hash key that is offset from the non-employed sub-string by L_{HOP} bytes.

15. The method of claim 13, further comprising:
for each search string that is longer than the shortest search string,
determining if a hash key comprising a sub-string of length L_{KEY} in the search string that was not employed to generate one of the hash values in the set of hash values for that search string matches a hash key used to generate a hash value in the combined set of hash values; and in response to finding a match,
removing a hash value in the combined set of hash values that was derived from a sub-string hash key that is offset from the non-employed sub-string by n(L_{HOP}+L_{KEY})−L_{KEY} bytes, wherein n comprises an integer and n>0.

16. A machine-readable medium, to store instructions that if executed on a network processor perform operations comprising:
extracting hash keys comprising one or more non-overlapping sub-strings from payload data in a network packet,
performing a hash on each of the one or more sub-strings;
determining if a hash result from a hash on a sub-string matches one of a plurality of search string hash values stored in a memory, and
providing an output indicating the search string is not present in the payload data if there are no matches between any of the hash results and the search string hash values.

17. The machine-readable medium of claim 16, wherein execution of the instructions cause further operations to be performed comprising:
detecting that a hash result from a sub-string matches one of the search string hash values stored in memory; and in response thereto,
performing a byte-by-byte comparison between the search string and strings comprising sequential byte combinations in the payload data to verify if the search string is present in the payload data.

18. The machine-readable medium of claim 16, wherein the network processor employs multiple threads operating on compute engines that perform fast path packet processing operations and the instructions comprise at least one execution thread, and wherein execution of the instructions cause further operations to be performed comprising:
detecting that a hash result from a sub-string matches one of the search string hash values stored in memory; and in response thereto,
forwarding continued string search operations to a slow processing path with indicia identifying a hash result match has been detected, the string search operations in the slow processing path to perform a full string search to determine whether the search string is present in the payload data.

19. The machine-readable medium of claim 16, wherein execution of the instructions cause further operations to be performed comprising:
skipping portions of the packet payload to locate the hash key sub-strings, wherein adjacent hash key sub-strings are separated by an offset of L_{HOP} bytes, and each sub-string has a length of L_{KEY} bytes.

20. The machine-readable medium of claim 16, wherein the memory comprises a content addressable memory (CAM), and wherein execution of the instructions cause further operations to be performed comprising:
submitting a sub-string to a hash unit;
receiving a hash result for the sub-string from the hash unit;
submitting the hash result to the CAM for comparison with the hash values stored in the CAM; and
reading an output of the CAM to determine if there is a match between the hash result and a hash value stored in the CAM.

21. A network processor, comprising:
an internal interconnect comprising sets of bus lines via which data and control signals are passed;
a plurality of compute engines, coupled to the internal interconnect, at least one compute engine including:
a processor core;
a local memory, coupled to the processor core;
a content addressable memory (CAM) coupled to the processor core; and
a local hash unit, coupled to the processor core.

22. The network processor of claim 21, wherein each of the plurality of compute engines includes a CAM, and a CAM for each compute engine that includes a local hash unit is larger than a CAM for a compute engine that does not include a local hash unit.

23. The network processor of claim 21, wherein an output of the local hash unit is operatively-coupled to an input for the CAM.

24. The network processor of claim 21, further comprising a general-purpose processor, coupled to the internal interconnect.

25. A network line card, comprising:
a network processor, comprising:
an internal interconnect comprising sets of bus lines via which data and control signals are passed;
a plurality of microengines, coupled to the internal interconnect, at least one microengine including:
a processor core;
a local memory, coupled to the processor core;
a content addressable memory (CAM) coupled to the processor core; and a local hash unit, coupled to the processor core; and
a storage unit in which instructions are stored, which if executed on the at least one microengine performs operations comprising,
loading a plurality of search string hash values into the CAM, the search strings hash values generated from hash keys comprising overlapping sub-strings contained in at least one search string;
loading payload data for a network packet received by the network line card into the local memory;
extracting hash keys comprising one or more non-overlapping sub-strings from payload data,
performing a hash on each of the one or more sub-strings to generate a respective hash result;
submitting each hash result to the CAM to determine if the hash result matches one of search string hash values stored in the CAM, and
providing an output indicating the search string is not present in the payload data if there are no matches between any of the hash results and the search string hash values in the CAM.

26. The network line card of claim 25, wherein the network processor further includes at least one hash unit.

27. The network line card of claim 26, wherein at least one of the microengines further includes a local cache unit.

28. The network line card of claim 25, wherein the network processor further comprises a general-purpose processor used to perform slow path packet processing operations, and wherein the network processor employs multiple threads operating on microengines that perform fast path packet processing operations and the instructions include microcode corresponding to one or more execution threads, and wherein execution of the instructions cause further operations to be performed comprising:
detecting that a hash result from a sub-string matches one of the search string hash values stored in the CAM; and in response thereto,
forwarding continued string search operations to the general-purpose processor with indicia identifying a hash result match has been detected, the string search operations to perform a full string search to determine whether the search string is present in the payload data.

29. The network line card of claim 28, wherein execution of a portion of the instructions on the general-purpose processor cause further operations to be performed comprising:
performing a byte-by-byte comparison between the search string and strings in the payload data to verify if the search string is present in the payload data.

30. The network line card of claim 25, wherein execution of the instructions cause further operations to be performed comprising:
skipping portions of the packet payload data to locate the hash key sub-strings used to generate the hash results, wherein adjacent sub-strings are separated by an offset of L_{HOP} bytes, and each sub-string has a length of L_{KEY} bytes.
